(19) United States
(12) Patent Application Publication
(10) Pub. No.: US 2010/0146109 A1
(43) Pub. Date: Jun. 10, 2010

(54) SYSTEM AND METHOD FOR NETWORK VIRTUALIZATION

(75) Inventor: Seong-Im Yoon, Chungcheongnam-do (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/619,046

(22) Filed: Nov. 16, 2009

(30) Foreign Application Priority Data
Dec. 5, 2008 (KR) 10-2008-0123209
Apr. 28, 2009 (KR) 10-2009-0037048

(51) Int. Cl. G06F 15/173

(52) U.S. Cl. 709/224

(57) ABSTRACT

A context-aware server is provided. The context-aware server includes an integrated interface unit and a virtualization information generating unit. The integrated interface unit receives context information of a terminal, user profile information, and network state information. The virtualization information generating unit generates virtualization information including network resource information allocated by using the network state information and at least one of the context information and the user profile information.

### CROSS-REFERENCE TO RELATED APPLICATIONS

This U.S. non-provisional patent application claims priority under 35 U.S.C. §119 of Korean Patent Application Nos. 10-2008-0123209, filed on Dec. 5, 2008, and 10-2009-0037048, filed on Apr. 28, 2009, the entire contents of which are hereby incorporated by reference.

### BACKGROUND OF THE INVENTION

The present invention disclosed herein relates to network virtualization systems, and more particularly, to systems and methods for network virtualization.

Ubiquitous environments enable users to freely use networks by accessing communication network systems anywhere anytime. In the ubiquitous environments, terminals are designed to provide various services in accordance with users' various demands.

The network systems accessed by the terminals are becoming more complicated with the advance of computing technologies. The advanced computing technologies have enabled the network systems to provide various services to the terminals in the ubiquitous environments by using network resources. However, unavailable network resources are increasing due to the insufficient flexibility of the network systems.

### SUMMARY OF THE INVENTION

The present invention provides network virtualization systems and methods for managing network resources flexibly.

Embodiments of the present invention provide context-aware servers including: an integrated interface unit receiving context information of a terminal, user profile information, and network state information; and a virtualization information generating unit generating virtualization information including network resource information allocated by using the network state information and at least one of the context information and the user profile information.

In some embodiments, the context information includes at least one of physical information of the user, environment information, and state information of the terminal; the physical information includes at least one of bodily temperature, blood pressure, pulse, electrocardiogram, and blood sugar; the environment information includes at least one of brightness, temperature, humidity, sound, movement speed, location, and vibration; and the state information of the terminal includes at least one of power state and operation state.

In other embodiments, the user profile information includes at least one of age, sex, physical information, and preference information.

In further embodiments, the network state information includes at least one of connection state information, bandwidth information, error information, service information, and capability information.

In still further embodiments, the network resource is a virtualized network resource.

In still further embodiments, the virtualization information is generated using at least one of the user profile information and the context information selected according to the service type of the terminal.

In still further embodiments, the context-aware servers further include: a context information processing unit processing the context information; a user profile information managing unit managing the user profile information; and a network state information managing unit managing the network state information.

In other embodiments of the present invention, methods for network virtualization of a context-aware server include: receiving context information of a terminal, user profile information, and network state information; selecting at least one of the user profile information and the context information of the terminal according to the service type of the user terminal; and generating virtualization information including network resource information allocated by using the network state information and the selected information.

In some embodiments, the context information includes at least one of physical information of the user, environment information, and state information of the terminal; the physical information includes at least one of bodily temperature, blood pressure, pulse, electrocardiogram, and blood sugar; the environment information includes at least one of brightness, temperature, humidity, sound, movement speed, location, and vibration; and the state information of the terminal includes at least one of power state and operation state.

In other embodiments, the user profile information includes at least one of age, sex, physical information, and preference information.

In further embodiments, the network state information includes at least one of connection state information, bandwidth information, error information, service information, and capability information.

In still further embodiments, the network resource is a virtualized network resource.

In further embodiments of the present invention, systems for network virtualization include: a programmable network device measuring network state information; and a context-aware server generating virtualization information including network resource information allocated by using the network state information and at least one of user profile information and context information of a terminal, wherein the programmable network device creates a virtual machine by using the virtualization information.

In some embodiments, the context information includes at least one of physical information of the user, environment information, and state information of the terminal; the physical information includes at least one of bodily temperature, blood pressure, pulse, electrocardiogram, and blood sugar; the environment information includes at least one of brightness, temperature, humidity, sound, movement speed, location, and vibration; and the state information of the terminal includes at least one of power state and operation state.

In other embodiments, the user profile information includes at least one of age, sex, physical information, and preference information.

In further embodiments, the network state information includes at least one of connection state information, bandwidth information, error information, service information, and capability information.

In still further embodiments, the network resource is a virtualized network resource.

In still further embodiments, the virtualization information is generated using at least one of the user profile information and the context information selected according to the service type of the terminal.

In still further embodiments, the context-aware server includes: an integrated interface unit receiving the context information of the terminal, the user profile information, and the network state information; and a virtualization information generating unit generating virtualization information including network resource information allocated by using the network state information and at least one of the context information and the user profile information.

In still further embodiments, the programmable network device includes: a network state information collecting unit collecting network state information; and a virtual machine creating unit creating a virtual machine by receiving the virtualization information.

In still further embodiments, the virtual machine creating unit creates the virtual machine so that the virtual machine operates in connection with another virtual machine.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram of a network virtualization system according to an exemplary embodiment of the present invention;

FIG. 2 is a block diagram of a terminal of FIG. 1 according to an exemplary embodiment of the present invention;

FIG. 3 is a block diagram of a context-aware server of FIG. 1 according to an exemplary embodiment of the present invention;

FIG. 4 is a block diagram of a programmable network device of FIG. 1 according to an exemplary embodiment of the present invention; and

FIG. 5 is a flow diagram illustrating an operational process of a network virtualization system according to an exemplary embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the following description, detailed descriptions of well-known functions or configurations will be omitted in order not to unnecessarily obscure the subject matters of the present invention.

The present invention provides network virtualization systems and methods for flexibly managing network resources by virtualizing the network resources.

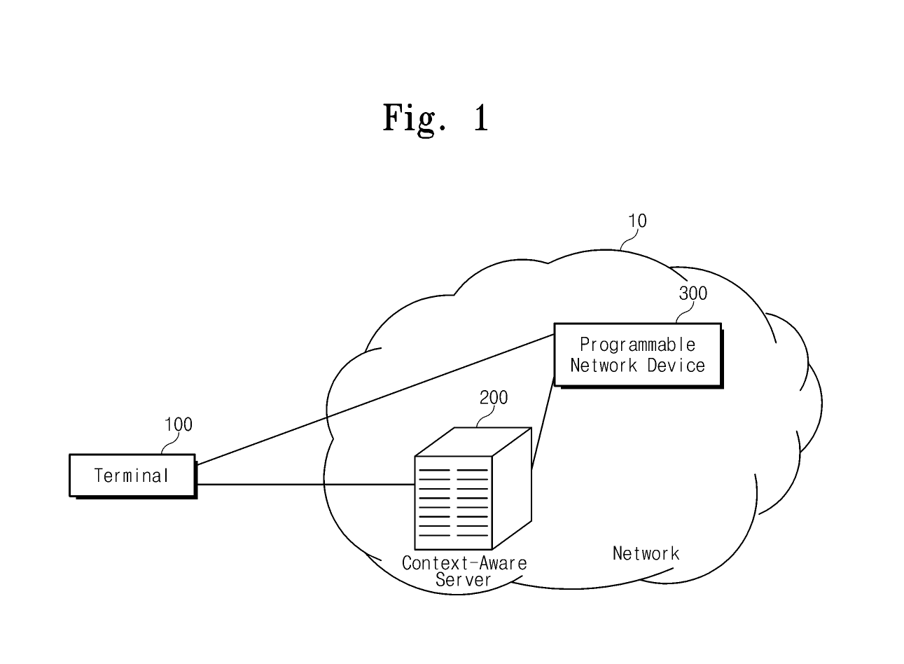

FIG. 1 is a block diagram of a network virtualization system according to an exemplary embodiment of the present invention.

Referring to FIG. 1, a network virtualization system includes a terminal 100, a context-aware server 200, and a programmable network device 300. The terminal 100 may be connected through a network 10 to each of the context-aware server 200 and the programmable network device 300.

The terminal 100 accesses the network 10 to provide various services to a user. The terminal 100 detects context information and user profile information for virtual machine (VM) creation. Examples of the terminal 100 include wired terminals, wireless terminals, and information electronic appliances.

The terminal 100 detects context information. The context information includes at least one of physical information of the user, environment information, and state information of the terminal 100. For example, the physical information of the user includes at least one of bodily temperature, blood pressure, pulse, electrocardiogram, and blood sugar; the environment information includes at least one of brightness, temperature, humidity, sound, movement speed, location, and vibration; and the state information of the terminal 100 includes at least one of power state and operation state.

The terminal 100 detects user profile information. The user profile information is personal information of the user. For example, the user profile information includes age, sex, physical information, and preference information.

The programmable network device 300 may include node functions or may be various nodes located on the network. Examples of the node include routers, switches, base stations, base station controllers, switching systems, load balancers, firewalls, and servers.

The programmable network device 300 collects its network state information. The network state information is state information of network resources. For example, the network state information includes at least one of connection state information, bandwidth information, error information, service information, and capability information. The connection state information is information about the connection with another programmable network device (or another node); the bandwidth information is available bandwidth information; the error information is information about a network error; the service information is available service information; and the capability information includes network capability information (e.g., data processing capability, data storage capability, and error correction capability).

The programmable network device 300 transmits the network state information to the context-aware server 200.

The context-aware server 200 receives the context information and the user profile information from the terminal 100, and receives the network state information from the programmable network device 300.

The context-aware server 200 generates virtualization information for virtual machine creation. The context-aware server 200 selects at least one of the context information and the user profile information according to the service type.

The context-aware server 200 uses the selected information and the network state information to allocate network resources. Herein, the allocated network resources are virtualized network resources. The virtualized network resources are a plurality of virtual machines created by virtualization software (S/W). The virtualization software is provided from the programmable network device (node) 300. To this end, the context-aware server 200 receives the virtualization software from the programmable network device 300. The context-aware server 200 generates virtualization information including allocated network resource information. Herein, the virtualization information is information about the physical resources of the programmable network device 300 that are virtualized according to the service type on the basis of the context of a corresponding point (i.e., the context information and the user profile information). The virtualization information is determined by the priority or combination conditions of information elements preselected on the basis of terminal context information, user profile information, and network state information.

The context-aware server 200 may generate virtualization information of other programmable network devices than the programmable network device 300.

The programmable network device 300 may download and use a module performing a specific function. The programmable network device 300 supports a network resource virtualization function through virtualization software technologies (e.g., Xen, Linux Vserver, EMC VMware, Intel Vanderpool, and Microsoft Virtual Server). The programmable network device 300 may support a network resource virtualization function for the context-aware server 200 when the context-aware server 200 generates virtualization information.

The programmable network device 300 receives virtualization information from the context-aware server 200. The programmable network device 300 creates a virtual machine according to the virtualization information. The programmable network device 300 creates the virtual machine so that it operates in connection with a virtual machine created by another programmable network device. That is, because the virtualization resources (virtual machines) of related programmable network devices must interconnect with each other in order to provide a certain service, the related programmable network devices share virtualization information with each other to create virtual machines.

Upon receiving a service request from the terminal 100, the programmable network device 300 uses the virtual machine to allocate network resources according to a requested service. The programmable network device 300 uses the allocated network resources to provide the requested service.

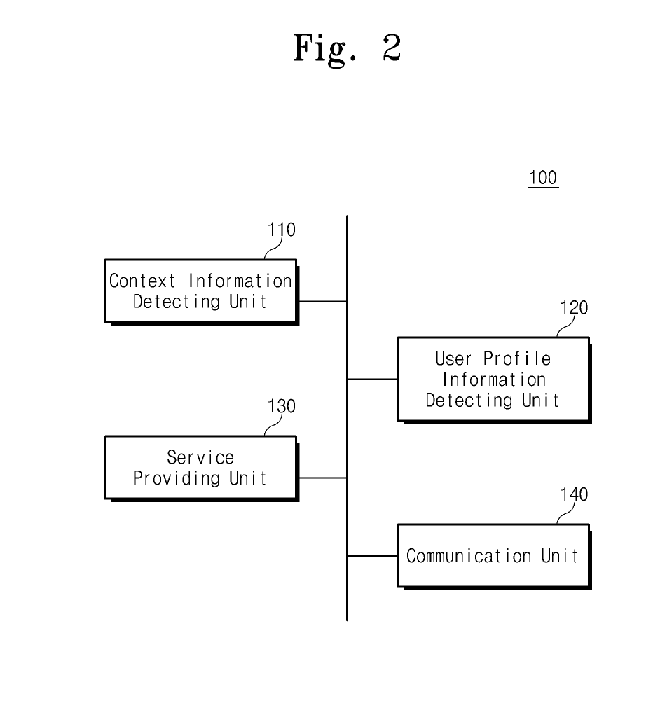

FIG. 2 is a block diagram of the terminal 100 of FIG. 1 according to an exemplary embodiment of the present invention.

Referring to FIG. 2, the terminal 100 includes a context information detecting unit 110, a user profile information detecting unit 120, a service providing unit 130, and a communication unit 140.

The context information detecting unit 110 may include a plurality of sensors for context information detection. Examples of the sensors include temperature sensors, vibration sensors, acceleration sensors, and motion sensors.

The context information detecting unit 110 may reflect variable context information by periodically detecting the context information of the terminal 100. The context information detecting unit 110 transmits the detected context information through the communication unit 140 to the context-aware server 200.

The user profile information detecting unit 120 may include an input unit for input of user profile information. Examples of the input unit include a keypad, a touchpad, a wheel mouse, and a keyboard. The user profile information detecting unit 120 detects user profile information inputted by the user. The user profile information detecting unit 120 transmits the detected user profile information through the communication unit 140 to the context-aware server 200.

The communication unit 140 transmits TX data of the terminal 100 and receives RX data of the terminal 100. The communication unit 140 transmits the context information and the user profile information to the context-aware server 200.

The service providing unit 130 includes units for service provision (e.g., an audio unit and a display unit). The service providing unit 130 provides services requested by the terminal 100. In order to provide each service, the service providing unit 130 drives an application corresponding to the service.

The terminal 100 may further include a memory (not illustrated) for storing the context information detected by the context information detecting unit 110 and the user profile information detected by the user profile information detecting unit 120.

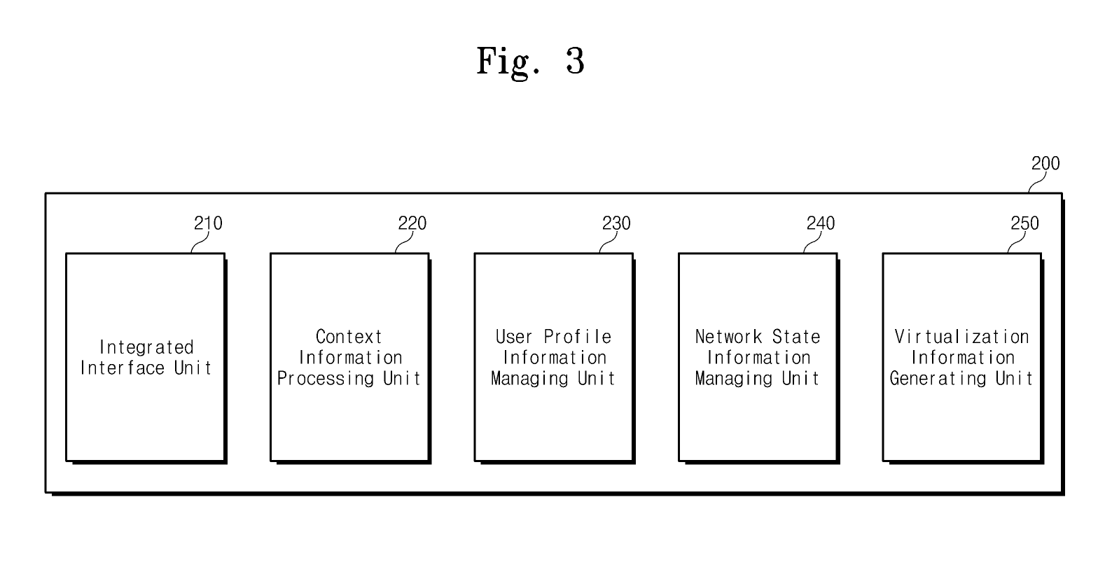

FIG. 3 is a block diagram of the context-aware server 200 of FIG. 1 according to an exemplary embodiment of the present invention.

Referring to FIG. 3, the context-aware server 200 includes an integrated interface unit 210, a context information processing unit 220, a user profile information managing unit 230, a network state information managing unit 240, and a virtualization information generating unit 250.

The integrated interface unit 210 is connected to each of the terminal 110 and the programmable network device 300. The integrated interface unit 210 receives the context information and the user profile information from the terminal 100, and receives the network state information from the programmable network device 300. The integrated interface unit 210 provides the context information to the context information processing unit 220, and provides the user profile information to the user profile information managing unit 230.

The context information processing unit 220 processes (e.g., interprets, stores and analyzes) the context information to generate the processed context information. The context information processing unit 220 may include a context information interpreting unit, a context information storing unit, and a context information analyzing unit for interpreting, storing and analyzing the context information. The context information processing unit 220 interprets the context information and stores the interpreted context information. The context information processing unit 220 analyzes the stored context information to generate the processed context information. Herein, the processed context information has a format processible by the virtualization information generating unit 250.

The user profile information managing unit 230 manages the user profile information. The user profile information managing unit 230 may include a user profile information storing unit for storing the user profile information. The user profile information managing unit 230 may reflect the updated user profile information on the prestored user profile information to manage the user profile information.

The network state information managing unit 240 manages the network state information. The network state information managing unit 240 may include a network state information storing unit for storing the network state information. The network state information managing unit 240 may reflect the updated network state information on the prestored network state information to manage the network state information.

The virtualization information generating unit 250 generates the virtualization information including the network resources allocated by using the context information processed by the context information processing unit 220, the user profile information of the user profile information managing unit 230, and the network state information of the network state information managing unit 240.

The virtualization information generating unit 250 virtualizes the network resources according to virtualization standards. The network resource virtualization is to group physical network resources into one network resource type according to the virtualization standards.

The virtualization standards are used to group physical network resources into one resource. For example, it is assumed that the virtualization standards are bandwidths for providing an IPv6 service. The virtualization information generating unit 250 groups bandwidths capable of IPv6 service provision into one IPv6 bandwidth resource.

The virtualization standards are not limited to the bandwidth resources but may vary depending on network virtualization methods. Through network resource virtualization, the virtualization information generating unit 250 regards physical network resources as logical network resources.

The virtualization information generating unit 250 generates virtualization information by optimally selecting the context information, the user profile information, and network state information that are received according to predetermined standards (e.g., priority or combination conditions). For example, the virtualization information generating unit 250 generates the virtualization information by using first information corresponding to the context information, second information corresponding to the user profile information, and third information corresponding to the network state information. Herein, it is assumed that the predetermined standards are priorities. If the second information and the third information have a higher priority than the first information, the virtualization information generating unit 250 may create a virtualization scheme by reflecting the second information and the third information first and referring to the first information.

The virtualization information generating unit 250 generates virtualization information by allocating the network resources virtualized according to the service type. The virtualization information generating unit 250 generates the network resources virtualized by using the network state information and at least one of the context information and the user profile information selected according to the service type. The virtualization information generating unit 250 generates virtualization information. Herein, the virtualization information includes allocation information of the network resources virtualized according to the service type. The virtualization information generating unit 250 generates the virtualization information so that a Quality of Service (QoS) is guaranteed.

The virtualization information generating unit 250 may generate the virtualization information for each terminal, each user, or each service. The virtualization information generating unit 250 may transmit the generated virtualization information through the integrated interface unit 210 to the programmable network device 300.

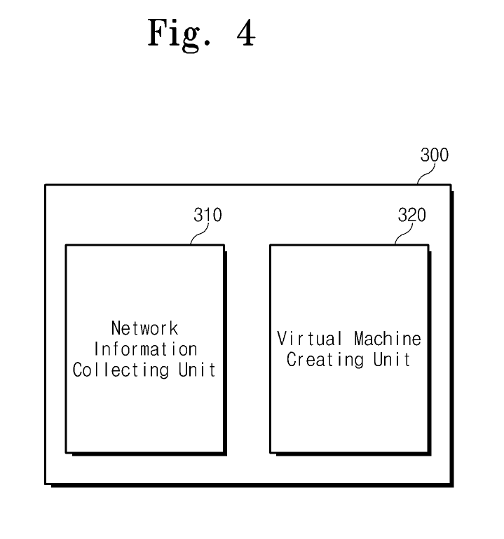

FIG. 4 is a block diagram of the programmable network device 300 of FIG. 1 according to an exemplary embodiment of the present invention.

Referring to FIG. 4, the programmable network device 300 includes a network information collecting unit 310 and a virtual machine creating unit 320.

The programmable network device 300 may include node functions or may be one of various nodes located on the network 10.

The network information collecting unit 310 collects network state information from a node including the programmable network device 300. The network information collecting unit 310 collects network state information including connection state information, bandwidth information, error information, service information, and capability information. The network information collecting unit 310 transmits the collected network state information to the context-aware server 200.

The virtual machine creating unit 320 receives the virtualization information from the context-aware server 200 and creates a virtual machine by using the received virtualization information. The virtual machine creating unit 320 creates a virtual machine so that it operates in connection with other virtual machines created by other programmable network devices. Also, the virtual machine creating unit 320 may create a plurality of virtual machines internally.

Herein, the virtual machine includes allocation information of the network resources virtualized according to the service type. Thus, upon receiving a service request from the terminal 100, the virtual machine creating unit 320 uses the virtual machine to allocate the virtualized network resources in response to the service request.

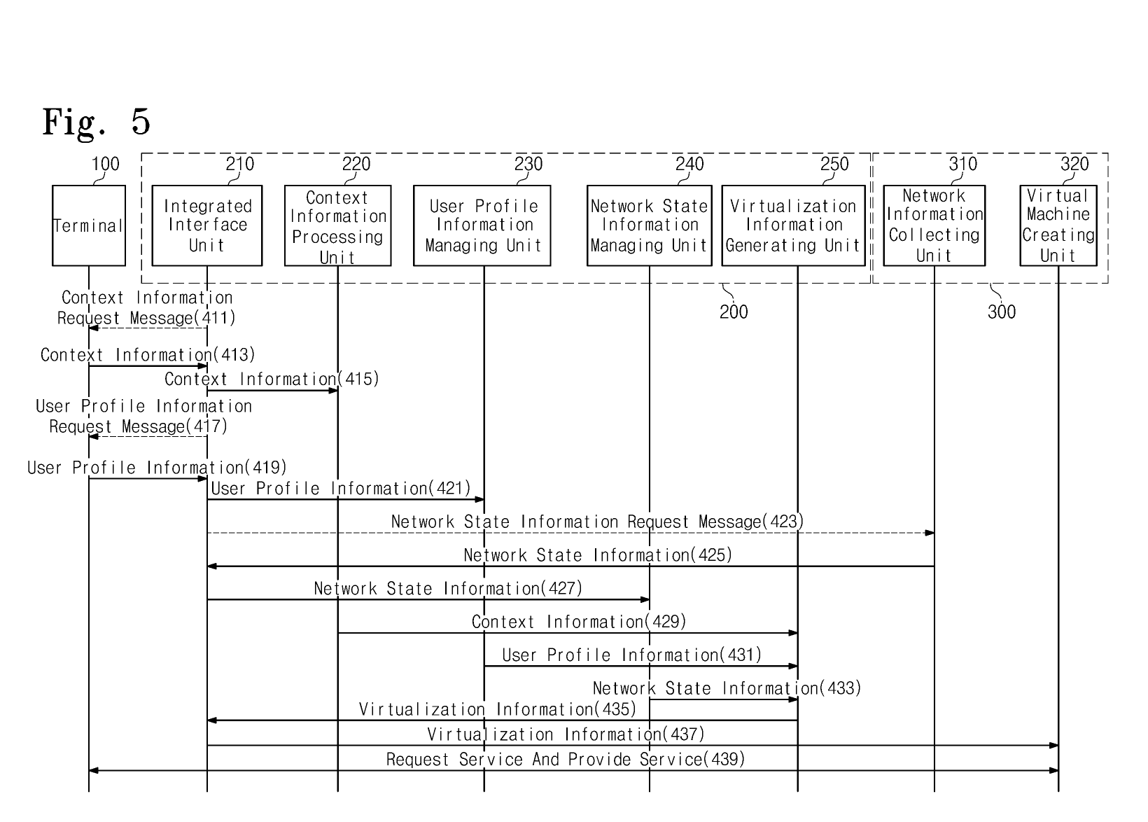

FIG. 5 is a flow diagram illustrating an operational process of a network virtualization system according to an exemplary embodiment of the present invention.

Referring to FIG. 5, the network virtualization system includes a terminal 100, a context-aware server 200, and a programmable network device 300. The context-aware server 200 includes an integrated interface unit 210, a context information processing unit 220, a user profile information managing unit 230, a network state information managing unit 240, and a virtualization information generating unit 250. The programmable network device 300 includes a network information collecting unit 310 and a virtual machine creating unit 320.

In operation 411, the integrated interface unit 210 transmits a context information request message to the terminal 100.

In operation 413, the terminal 100 transmits context information to the integrated interface unit 210.

In operation 415, upon receiving the context information from the terminal 100, the integrated interface unit 210 transmits the received context information to the context information processing unit 220.

In operation 417, the integrated interface unit 210 transmits a user profile information request message to the terminal 100.

In operation 419, the terminal 100 transmits user profile information to the integrated interface unit 210.

In operation 421, upon receiving the user profile information from the terminal 100, the integrated interface unit 210 transmits the received user profile information to the user profile information managing unit 230.

In operation 423, the integrated interface unit 210 transmits a network state information request message to the network information collecting unit 310.

In operation 425, the network information collecting unit 310 transmits network state information to the integrated interface unit 210.

In operation 427, upon receiving the network state information from the network information collecting unit 310, the integrated interface unit 210 transmits the received network state information to the network state information managing unit 240.

The integrated interface unit 210 may periodically transmit the context information request message, the user profile information request message, and the network state information request message. The integrated interface unit 210 may selectively transmit the context information request message, the user profile information request message, and the network state information request message.

In operation 429, the context information processing unit 220 transmits the context information to the virtualization information generating unit 250.

In operation 431, the user profile information managing unit 230 transmits the user profile information to the virtualization information generating unit 250.

In operation 433, the network state information managing unit 240 transmits the network state information to the virtualization information generating unit 250.

The operations of the integrated interface unit 210 for receiving (or requesting) the context information, the user profile information, and the network state information are not limited to the above illustrated sequence. Also, the operations of the virtualization information generating unit 250 for requesting the context information, the user profile information, and the network state information are not limited to the above illustrated sequence.

The virtualization information generating unit 250 generates virtualization information allocating network resources, by using the context information, the user profile information, and the network state information.

In operation 435, the virtualization information generating unit 250 transmits the generated virtualization information to the integrated interface unit 210.

In operation 437, the integrated interface unit 210 transmits the virtualization information to the virtual machine creating unit 320.

The virtual machine creating unit 320 creates a virtual machine by using the received virtualization information. The virtual machine creating unit 320 creates the virtual machine so that it operates in connection with virtual machines created by other programmable network devices.

In operation 439, upon completion of the virtual machine creation, the terminal 100 transmits a service request message to the virtual machine creating unit 320 or receives a service from the virtual machine creating unit 320. The terminal 100 is allocated network resources virtualized (or a virtual machine) on the basis of the context information or the user profile information. The terminal 100 may provide a service to the user through the allocated network resources.

According to the present invention, the virtual machine of the network virtualization system is created on the basis of the virtualized network resources.

Thus, the network virtualization system can flexibly manage the network resources that were unavailable due to the flexibility insufficiency. Also, the network virtualization system can correct an error in a specific network and can transmit large data of a specific network.

As described above, the network virtualization system of the present invention virtualizes network resources on the basis of virtualized network state information, thereby making it possible to flexibly manage and efficiently use the network resources.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A context-aware server comprising:
an integrated interface unit receiving context information of a terminal, user profile information, and network state information; and
a virtualization information generating unit generating virtualization information including network resource information allocated by using the network state information and at least one of the context information and the user profile information.

2. The context-aware server of claim 1, wherein the context information includes at least one of physical information of the user, environment information, and state information of the terminal;
the physical information includes at least one of bodily temperature, blood pressure, pulse, electrocardiogram, and blood sugar;
the environment information includes at least one of brightness, temperature, humidity, sound, movement speed, location, and vibration; and
the state information of the terminal includes at least one of power state and operation state.

3. The context-aware server of claim 1, wherein the user profile information includes at least one of age, sex, physical information, and preference information.

4. The context-aware server of claim 1, wherein the network state information includes at least one of connection state information, bandwidth information, error information, service information, and capability information.

5. The context-aware server of claim 1, wherein the network resource is a virtualized network resource.

6. The context-aware server of claim 1, wherein the virtualization information is generated using at least one of the user profile information and the context information selected according to the service type of the terminal.

7. A method for network virtualization of a context-aware server, comprising:
receiving context information of a terminal, user profile information, and network state information;
selecting at least one of the user profile information and the context information of the terminal according to the service type of the user terminal; and
generating virtualization information including network resource information allocated by using the network state information and the selected information.

8. The method of claim 7, wherein the context information includes at least one of physical information of the user, environment information, and state information of the terminal;
the physical information includes at least one of bodily temperature, blood pressure, pulse, electrocardiogram, and blood sugar;
the environment information includes at least one of brightness, temperature, humidity, sound, movement speed, location, and vibration; and
the state information of the terminal includes at least one of power state and operation state.

9. The method of claim 8, wherein the user profile information includes at least one of age, sex, physical information, and preference information.

10. The method of claim 8, wherein the network state information includes at least one of connection state information, bandwidth information, error information, service information, and capability information.

11. The method of claim 8, wherein the network resource is a virtualized network resource.

12. A system for network virtualization, comprising:
a programmable network device measuring network state information; and
a context-aware server generating virtualization information including network resource information allocated by using the network state information and at least one of user profile information and context information of a terminal,
wherein the programmable network device creates a virtual machine by using the virtualization information.

13. The system of claim 12, wherein the context information includes at least one of physical information of the user, environment information, and state information of the terminal;
the physical information includes at least one of bodily temperature, blood pressure, pulse, electrocardiogram, and blood sugar;
the environment information includes at least one of brightness, temperature, humidity, sound, movement speed, location, and vibration; and
the state information of the terminal includes at least one of power state and operation state.

14. The system of claim 12, wherein the user profile information includes at least one of age, sex, physical information, and preference information.

15. The system of claim 12, wherein the network state information includes at least one of connection state information, bandwidth information, error information, service information, and capability information.

16. The system of claim 12, wherein the network resource is a virtualized network resource.

17. The system of claim 12, wherein the virtualization information is generated using at least one of the user profile information and the context information selected according to the service type of the terminal.

18. The system of claim 12, wherein the context-aware server comprises:
an integrated interface unit receiving the context information of the terminal, the user profile information, and the network state information; and
a virtualization information generating unit generating virtualization information including network resource information allocated by using the network state information and at least one of the context information and the user profile information.

19. The system of claim 12, wherein the programmable network device comprises:
a network state information collecting unit collecting network state information; and
a virtual machine creating unit creating a virtual machine by receiving the virtualization information.

20. The system of claim 19, wherein the virtual machine creating unit creates the virtual machine so that the virtual machine operates in connection with another virtual machine.
